(19) United States
(12) Patent Application Publication
(10) Pub. No.: US 2013/0258827 A1
(43) Pub. Date: Oct. 3, 2013

(54) OPTICAL DISK, FORMAT PROCESSING METHOD FOR THE SAME, RECORDING METHOD FOR THE SAME, AND OPTICAL DISK DEVICE

(71) Applicant: Hitachi Consumer Electronics Co., Ltd., Tokyo (JP)

(72) Inventors: Shinsuke IZAWA, Tokyo (JP); Masayuki HIRABAYASHI, Tokyo (JP)

(73) Assignee: Hitachi Consumer Electronics Co., Ltd., Tokyo (JP)

(21) Appl. No.: 13/784,567

(22) Filed: Mar. 4, 2013

(30) Foreign Application Priority Data
Mar. 23, 2012 (JP) 2012-066525

(51) Int. Cl. G11B 7/007

(52) U.S. Cl. CPC G11B 7/007
USPC 369/44.26; 369/275.4

(57) ABSTRACT

An optical disk that enables a laser beam to be focused on an object track without making mistakes, an optical disk device, a format processing method, and a recording method. The optical disk shall be configured to has a guiding layer with a physical groove structure containing address information and a single or multiple recording layers with no groove structure, in which the guide areas for recording the address information thereon are formed along a track of the guide layer at fixed intervals in a user data area of each recording layer. An address for the recording layer is generated based on information obtained from the guide layer, and the address for the recording layer is recorded in the guide area.

### TECHNICAL FIELD

The present invention relates to an optical disk, an optical disk device for reproducing information from the optical disk or recording information on the optical disk using a laser, a format processing method, and a recording method.

As a background art, there is Japanese Unexamined Patent Application Publication No. 2002-245636, for example. A problem of the summary of Japanese Unexamined Patent Application Publication No. 2002-245636 describes “providing an information recording medium that makes it possible to prevent a damage caused by data corruption in accompany with track coming-off of a light beam without reducing a storage capacity of user data.” Then, its solution means describes: an information recording medium (1) has recording tracks (#n+1, #n, and #n−1), multiple address areas (2) that are provided on these recording tracks and in which address information is recorded, multiple marker areas (3) that are areas provided in these address areas, are provided with fixed intervals being set, and have marker information therein. The address information is recorded in the address areas by means of pits, and the marker information is recorded in the marker areas by means of wobble that serves as a part of a track boundary.

### SUMMARY

In recent years, in the optical disk of Blu-ray Disc™ standard, optical disks having recording layers (three layers and four layers) have been developed in addition to the conventional disks having one and two layers. Although it is expected that development of the optical disk having a further recording layer will be conducted from now on aiming at a further large capacity, it is difficult to laminate many layers each having a physical groove structure in terms of manufacture of the disk. Then, in order to facilitate the manufacture even in the case of laminating many recording layers, there is proposed an optical disk (hereinafter described as a grooveless disk) in which a layer (hereinafter described as a guide layer) with a physical groove structure containing an address for performing addressing and a tracking serve control is provided, and that includes a layer with no physical groove structure, such as a land/groove structure, in which recording and reproduction is performed (hereinafter, described as the recording layer).

In the grooveless disk whose structure has no track groove in this recording layer, a technique of focusing a laser beam on an object track without making mistakes becomes important.

The grooveless disk has a guide layer with a wobble structure and multiple recording layers with neither the track groove nor the wobble structure. When performing recording and reproduction on/from the grooveless disk, tracking of a laser spot focusing on the recording layer is performed by information from a laser spot focusing on the guide layer. However, when the disk is taken out once from a drive and appending is performed after loading is redone, there is a case where it is impossible to perform the recording by following a track in parallel to an already-written track because adjustment values of a tilt adjustment, a lens shift adjustment, etc. are different. In this case, since the recording is performed by track following that is slanted to the already-recorded portion, overwriting, etc. occurs, which causes data corruption of the already-recorded portion. Moreover, when the disk is taken out once from the drive and the appending is performed after the loading is redone, if the recording with different tilt in a track direction is allowed in each recording, it will be difficult to calculate an optimum adjustment value in each track at the time of reproduction.

The above-mentioned Japanese Unexamined Patent Application Publication No. 2002-245636 describes a method for recording an address area and a marker area. However, in Japanese Unexamined Patent Application Publication No. 2002-245636, address information is recorded in the address area with pits, and the marker information is recorded with wobble that serves as a part of a track boundary. Since the grooveless disk has no pits and no wobble structure in the recording layer, Japanese Unexamined Patent Application Publication No. 2002-245636 cannot solve the above-mentioned problem.

The present invention is made in view of this actual situation, and aims at providing an optical disk such that a laser beam can be focused on an object track without making mistakes, an optical disk device, a format processing method therefor, and a recording method therefor.

The above-mentioned problem is solved, for example, by an invention described in the scope of claim for patent.

According to the present invention, it is possible to provide an optical disk such that a laser beam is focused on an object track thereof without making mistakes, an optical disk device, a formatting method, and a recording method.

Problems, configurations, and effects except what is described above will be clarified by following explanations of embodiments.

### BRIEF DESCRIPTION OF THE DRAWINGS

FIG. 1 is a diagram showing a structure of an optical disk according to this embodiment;

FIG. 2 is a diagram about a guide area of the optical disk according to this embodiment;

FIG. 3 is a diagram of a guide area check processing before recording according to this embodiment;

FIG. 4 is a diagram showing a guide area and user data according to this embodiment;

FIG. 5 is a diagram showing one embodiment of an optical disk device according to this embodiment;

FIG. 6 is a diagram showing one embodiment of a signal processing unit according to this embodiment;

FIG. 7 is a flowchart about a processing from insertion of the disk to establishment of a recordable or reproducible state;

FIG. 8 is a flowchart about a format processing according to this embodiment;

FIG. 9 is a flowchart about a recording processing using the guide area according to this embodiment;

FIG. 10 is a flowchart about a recording processing using the guide area according to this embodiment;

FIG. 11 is a flowchart about a recording processing of recording also on the guide area at the time of recording the user data according to this embodiment; and

FIG. 12 is a flowchart about a recording processing of another embodiment using the guide area according to this embodiment.

### DETAILED DESCRIPTION

Hereinafter, embodiments of the present invention will be described based on drawings.

### First Embodiment

This embodiment is for performing track following that is always in parallel to an object track by defining an area called a guide area in recording with different loading on a grooveless disk in consideration of a case where the recording cannot be performed using the track following in parallel to an already-recorded track because adjustment values of a tilt adjustment, a lens shift adjustment, etc. are different.

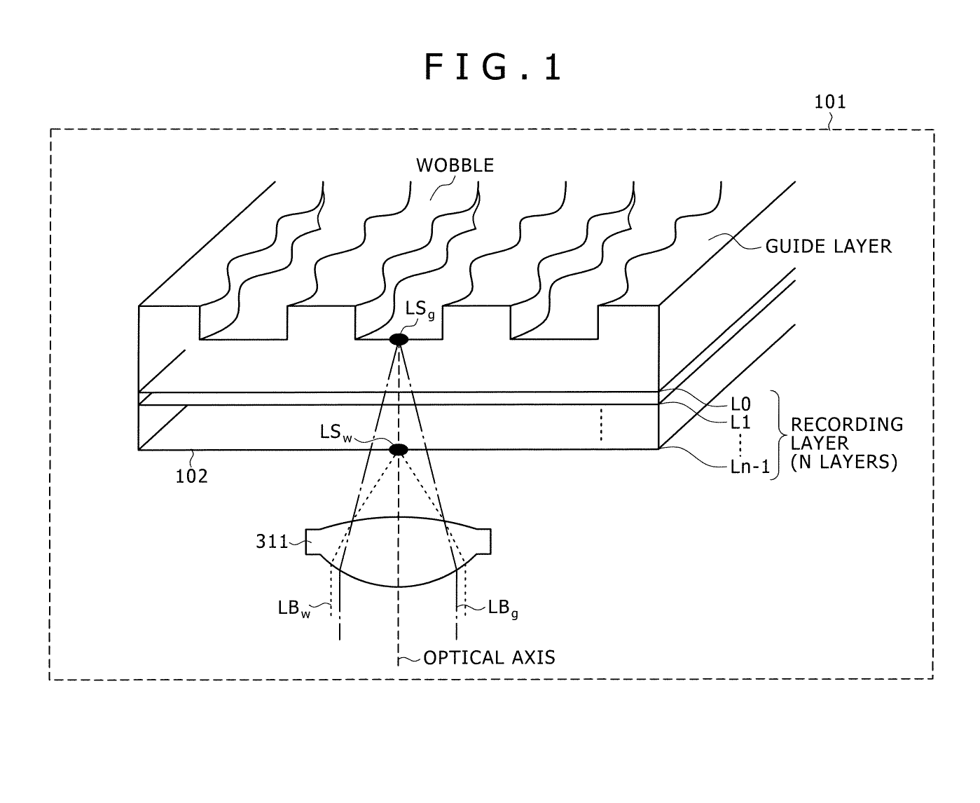

A structure of an optical disk 102 used in this embodiment is illustrated in FIG. 1.

The optical disk 102 has a guide layer with a structure of a track (guide groove) and N recording layers (N≧1 and N is a natural number) without the structure of a track. In an optical disk device 101, an objective lens 311 produces laser spots LSw and LSg on the recording layer and on the guide layer, respectively. In order to perform a tracking control of the laser spots LSw and LSg, a continuous groove in a spiral shape is formed on the guide layer.

Using this groove structure, the optical disk device 101 generates a timing of recording on the recording layer, and also obtains information of an address, etc. In order to let the guide layer have these pieces of information, the groove on the guide layer has been subjected to wobble modulation. A timing and address information by MSK (Minimum Shift Keying) modulation is incorporated in the wobble and three addresses are assigned to an RUB (Record unit Block) that is a main data unit of every 64 KB to be written in the recording layer.

Moreover, in order to transcribe the address information to a head of 1-ECC cluster unit that is a user data record unit in the recording layer, the information is embedded in the wobble so that the address information can be obtained at the end of the 1-ECC cluster unit of the guide layer. However, the above unit is one example and embedding of the information is not limited to this example.

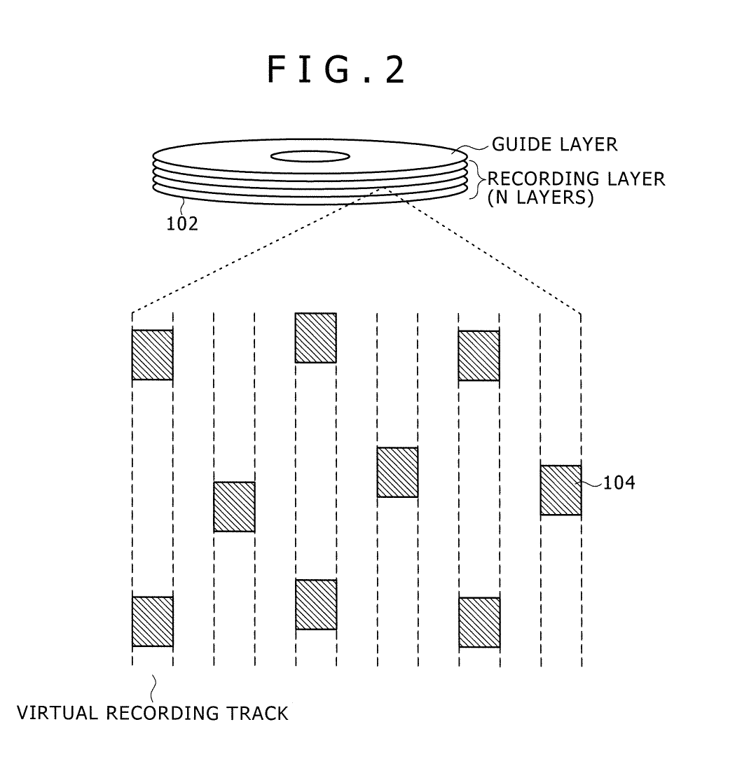

FIG. 2 shows a diagram about a guide area 104 of the optical disk 102 of a first embodiment according to the present invention.

The figure shows a diagram that enlarges a certain area of the recording layer. The optical disk 102 has the guide area 104 at fixed intervals prescribed beforehand in the recording layer. Incidentally, this guide area is in a non-recorded state in an initial stage (at the time of manufacture). An address value of a position at which the laser beam is focusing on the recording layer at this time is decided from the address information obtained from the wobble of the guide layer and layer information whereby a layer on which the laser beam is focusing is distinguished among multiple recording layers. The guide area 104 is an area for recording this address value. For example, when the address described at that location of the guide layer is “12C000”, if the recording layer on which the laser beam is focusing is L0, “1” will be added to an address head to determine the address value to change it to “112C000,” and if the recording layer on which the laser beam is focusing is L5, “6” will be added to the address head to decide the address value as “612C000,” and the address information will be recorded in the guide area.

Incidentally, the method for determining the address value of each layer described here is one example, and the method is not limited to this example. Moreover, although the example where the address information was recorded in the guide area was shown here, information, such as control data and a sync pattern, may be recorded in addition to this information.

By performing a check processing of referring to the address information of this guide area 104, it is possible to perform the recording along a virtual recording track even on the recording layer of the grooveless disk with no track groove structure.

Incidentally, regarding the guide area, the optical disk may have guide areas in a user data area thereof over the whole surface at fixed intervals, the optical disk may have a management area in its inner or outer periphery and may have the guide areas in the area, or the optical disk may have the guide areas only in a certain designated zone in the user data area.

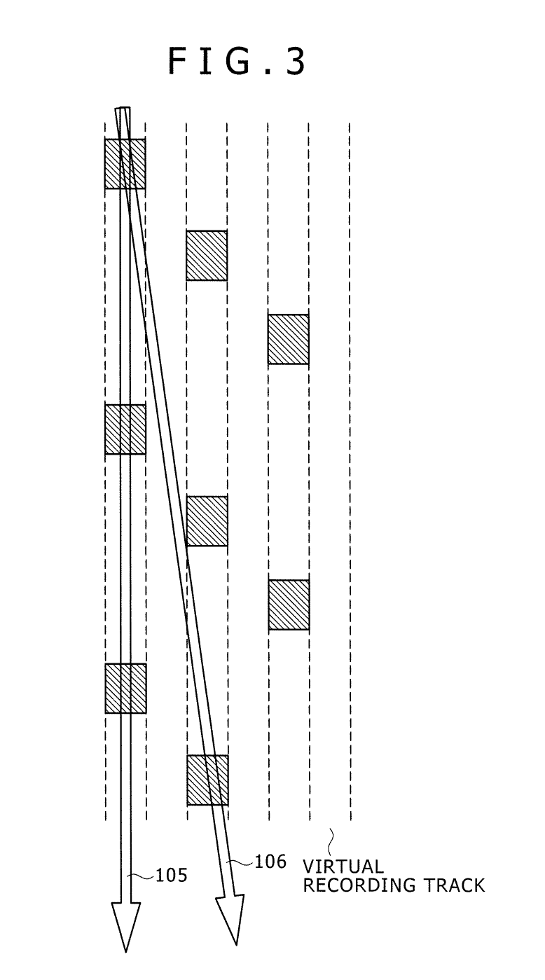

FIG. 3 shows a diagram about a guide area check processing prior to the recording. Arrows 105 and 106 show a scanning direction of the laser spot. If the scanning direction is one that agrees with the virtual recording track along the guide areas recorded in advance like the arrow 105, the address values of the guide areas will be reproduced continuously. However, if the scanning direction is one that is deviated from the virtual recording track along the guide areas recorded in advance like the arrow 106, the next guide area will not be reproduced even after reproducing a predetermined length; if a guide area of an other track happens to be reproduced, the address values will become non-continuous. Therefore, it can be determined that the scan is not one that is parallel to the virtual recording track along the guide areas recorded beforehand, and it is possible to set the scan parallel to the virtual recording track along the guide areas by redoing an adjustment processing, such as a tilt control.

As the adjustment processing method, there is a method for performing the check processing of the guide area, for example, by simply redoing the usual adjustment procedure. Alternatively, the check processing of the guide area may be redone after shifting the current adjustment value by the value of a fixed quantity prescribed beforehand, and this may be repeated until the scanning direction becomes one that agrees with the virtual recording track along the guide areas recorded in advance.

A trigger at which the guide area check processing is started is set at a time when the seek processing is started and the address values to be recorded becomes non-continuous and at a time when the guide area is partitioned into fixed zones prescribed beforehand at each radius position. Alternatively, the whole surface of the recording layer may be checked simultaneously.

When address continuity is lost at the time of recording, it is determined that the track following comes off from the virtual track and the recording is interrupted. After the interruption, the guide area check processing is redone at a position where the track following came off, an area from the position where the address continuity is lost to a position where non-continuous addresses are detected is designated as a defect area, and an alteration processing is performed. After this, the recording is succeedingly resumed from an address after the defect area.

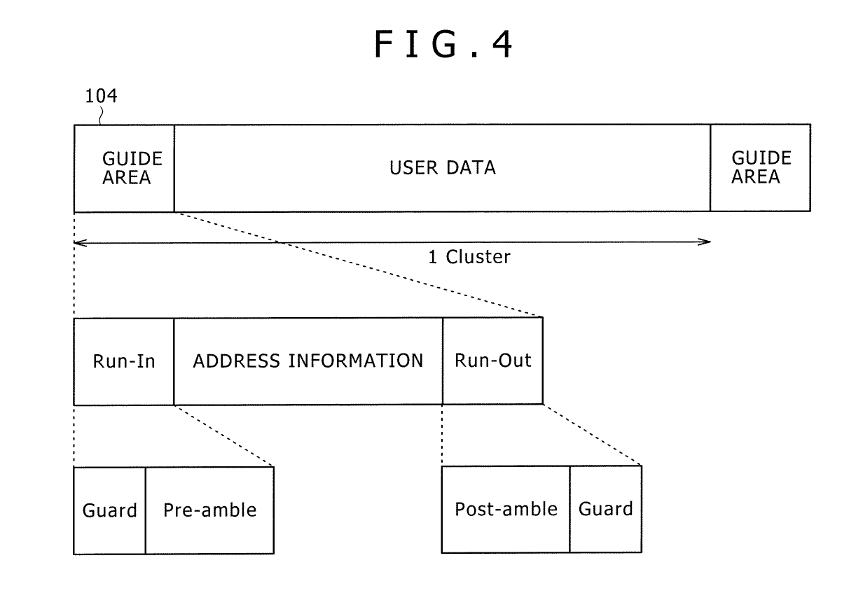

FIG. 4 is a diagram showing the guide area 104 and user data.

The recording is performed in the guide area by 1-ECC cluster unit (hereinafter, abbreviated to a cluster), and an area for recording the user data is provided in an area between the guide area and the guide area. For example, user data of 64 KB is stored in one ECC cluster.

Incidentally, although the record unit of the guide area was set to a single cluster here, the recording may be performed in every cluster at fixed intervals prescribed beforehand or every track or the like, but not limited to this unit. The address information obtained from the guide layer and relevant address information of the guide layer are recorded in this guide area. In this embodiment, the recording of this guide area is performed by the format processing, and adjustment assistance is performed by reproducing the guide area prior to the recording and performing the check processing.

In the guide area, data equivalent to Run-In/Run-Out is recorded at both ends of the area, which enables a start position and an end position at the time of reproduction to be distinguished. Run-In/Run-Out has a Guard area used as a joint of data and an area of Pre-amble/Post-amble for determining the start position and the end position of the signal processing. In the Guard area, a fixed pattern prescribed beforehand is recorded, for example, which is intended to cope with overlapping of the joint of the data.

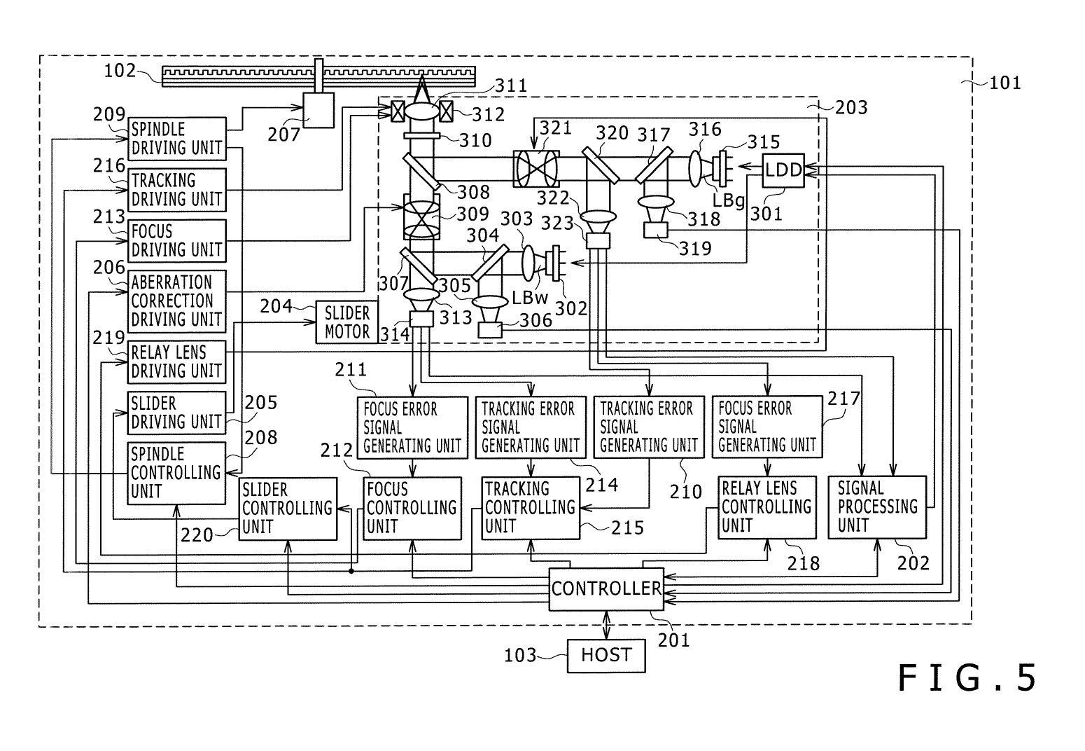

FIG. 5 is a block configuration diagram showing one embodiment of an optical disk device according to the present invention. The optical disk device 101 performs recording or reproduction of information by irradiating the optical disk 102 mounted on the device with the laser beam, and communicates with a host 103, such as a PC (Personal Computer), through an interface of SATA (Serial Advanced Technology Attachment), etc.

This optical disk device 101 includes a controller 201; a signal processing unit 202; an optical pickup 203; a slider motor 204 for moving the optical pickup 203 to a radial direction of the optical disk 102; a slider driving unit 205 for driving the slider motor 204; an aberration correction driving unit 206 for driving a spherical aberration correction element 309 provided in the optical pickup 203; a spindle motor 207 for rotating the optical disk 102; a spindle controlling unit 208 for generating a rotation signal for rotating the spindle motor 207; a spindle driving unit 209 that drives the spindle motor 207 in response to the rotation signal generated by the spindle controlling unit 208 and generates an FG signal of a frequency corresponding to a rotational speed of the spindle motor 207; a focus error signal generating unit 211 for generating a recording layer focus error signal that indicates the amount of deviation between the recording layer of the optical disk 102 and a focal position of a laser spot LSw; a focus controlling unit 212 for generating a focus driving signal according to the recording layer focus error signal; a focus driving unit 213 for driving an actuator 312 provided in the optical pickup 203 according to the focus driving signal; a tracking error signal generating unit 214 for generating a recording layer tracking error signal that indicates the amount of deviation between a recording layer track and the position of the laser spot LSw on the recording layer; a tracking error signal generating unit 210 for generating a guide layer tracking error signal that indicates the amount of positional deviation between the guide layer track of the optical disk 102 and a laser spot LSg on the guide layer; a tracking controlling unit 215 for generating a tracking driving signal according to the recording layer tracking error signal or the guide layer tracking error signal; a tracking driving unit 216 for driving the actuator 312 according to the tracking driving signal; a focus error signal generating unit 217 for generating a guide layer focus error signal that indicates the amount of deviation between the guide layer of the optical disk 102 and a focal position of the laser spot LSg; a relay lens controlling unit 218 for generating a relay lens driving signal according to the guide layer focus error signal; and a relay lens driving unit 219 for driving a relay lens 321 according to the relay lens driving signal.

The optical pickup 203 performs a servo control to the guide layer, and includes a guide layer optical system for reproducing an address corresponding to a position on the disk and information peculiar to the disk and a recording layer optical system for recording and reproducing in/from the multiple recording layers each of which has a different distance from the guide layer.

First, an operation of the recording layer optical system will be explained. A laser driver 301 is controlled by the controller 201, and outputs a current for driving a laser diode 302. This drive current is superimposed with a high frequency signal of a few hundred MHz in order to control a laser noise.

The laser diode 302 emits a laser beam LBw of 405 nm wavelength in a waveform according to the drive current. The emitted laser beam becomes a parallel beam by a collimating lens 303, and a part of the beam is reflected by a beam splitter 304 and is made to focus on a power monitor 306 by a condenser lens 305.

The power monitor 306 feeds back a current or voltage depending on the intensity of the laser beam to the controller 201. By this, the intensity of the laser beam LBw focusing on the recording layer of the optical disk 102 is kept at a desired value, for example, 2 mW, etc.

On the other hand, the laser beam LBw that penetrated the beam splitter 304 reflects on a polarizing beam splitter 307, its convergence and divergence are controlled by the spherical aberration correction element 309 driven by the aberration correction driving unit 206, and penetrates a dichroic mirror 308. The dichroic mirror 308 is an optical element for reflecting light of a specific wavelength and allowing lights of other wavelengths to penetrate itself. Here, it shall allow light of 405 nm wavelength to penetrate itself and reflect light of 650 nm wavelength.

The laser beam LBw that penetrated the dichroic mirror 308 is converted into circularly polarized light by a quarter wavelength plate 310, and focuses on the recording layer of the optical disk 102 with the objective lens 311 as the laser spot LSw. Here, the spherical aberration correction element 309 is controlled so that the laser spot LSw may be at a predetermined position according to the recording layer of the grooveless disk by the controller 201 through the aberration correction driving unit 206.

The laser beam LBw reflected by the optical disk 102 is modulated in intensity according to information recorded on the optical disk 102. It is converted into linearly polarized light by the quarter wavelength plate 310, passes through the dichroic mirror 308, and penetrates the polarizing beam splitter 307 and the spherical aberration correction element 309. The penetrated laser beam LBw is made to focus on a detector 314 by a condenser lens 313. The detector 314 detects the intensity of the laser beam LBw, and outputs a signal depending on this to the signal processing unit 202.

Moreover, the focus error signal generating unit 211 generates the recording layer focus error signal with respect to the recording layer from a signal outputted from the detector 314. With a command signal from the controller 201, the focus controlling unit 212 outputs the focus driving signal corresponding to the focus error signal to the focus driving unit 213. The focus driving unit 213 displaces a position of the objective lens 307 in a direction perpendicular to the recording surface by driving the actuator 312 according to the focus driving signal, and performs a recording layer focus servo control so that the laser beam LBw may become in focus on the recording layer.

The signal outputted from the detector 310 is also inputted into the tracking error signal generating unit 214, which generates the recording layer tracking error signal with respect to the recording layer. With a control signal from the controller 201, the tracking controlling unit 215 outputs the tracking driving signal corresponding to an output of the tracking error signal generating unit 214 or the tracking error signal generating unit 210 to the tracking driving unit 216.

Next, the guide layer optical system will be explained. Similarly with the recording layer optical system, the laser driver 301 is controlled by the controller 201 and outputs a current for driving a laser diode 315. The laser diode 315 emits a laser beam LBg of 650 nm wavelength, for example. A part of the laser beam LBg passes through a collimating lens 316, a beam splitter 317, and a condenser lens 318 and its power is monitored by a power monitor 319. By feeding back the monitored power to the controller 201, the intensity of the laser beam LBg focusing on the guide layer of the optical disk 102 is kept at a desired power, for example, 3 mW, etc.

The laser beam LBg that penetrated the beam splitter 317 penetrates a polarizing beam splitter 320, and its convergence and divergence are controlled by the relay lens 321. The laser beam LBg that passed through the relay lens 321 reflects on the dichroic mirror 308, passes through the quarter wavelength plate 310, and is made to focus on the guide layer of the optical disk 102 by the objective lens 311 as the laser spot LSg. The laser beam LBg that reflected on the optical disk 102 is reflected by the polarizing beam splitter 320, and is made to focus on a detector 323 by a condenser lens 322.

The detector 323 detects the intensity of the laser beam and outputs a signal according to this to the signal processing unit 202. The signal processing unit 202 generates a synchronizing signal for controlling rotation of the optical disk 102 and a clock signal serving as a standard at the time of performing recording or reproduction by a signal that is outputted from the detector 323 and corresponds to the track formed by wobbling on the guide layer, reproduces an address corresponding to a position on the disk that the laser spot LSg follows, and outputs it to the controller 201.

In this embodiment, an address value corresponding to a position on the optical axis of the recording layer is generated from the address information obtained by reproducing this guide layer, and is recorded in each guide area. The synchronizing signal outputted from the signal processing unit 202 and the FG signal outputted from the spindle driving unit 209 are inputted into the spindle controlling unit 209.

With the control signal from the controller 201, the spindle controlling unit 209 outputs a spindle driving signal based on the FG signal of a frequency corresponding to the rotational speed of the spindle motor 207 when the optical disk 102 is rotated at a constant angular velocity, and outputs a spindle driving signal based on the synchronizing signal reproduced from the guide layer when the optical disk 102 is rotated at a constant linear velocity.

The spindle driving unit 212 performs a spindle control so that the number of revolutions of the optical disk may become a predetermined value by driving the spindle motor 207 according to the spindle driving signal. The focus error signal generating unit 217 generates the guide layer focus error signal corresponding to a deviation between the guide layer of the optical disk 102 and an in-focus position of the laser spot LSg from the signal outputted from the detector 323; the relay lens controlling unit 218 generates the relay lens driving signal according to the guide layer focus error signal.

The relay lens driving unit 219 performs a guide layer focus servo control so that the laser spot LSg may become in focus on the guide layer by driving the relay lens 321 according to the relay lens driving signal. Moreover, with the signal outputted from the detector 323, the tracking error signal generating unit 210 generates the guide layer tracking error signal that corresponds to a deviation between a track of the guide layer of the optical disk 102 and a position of the laser spot LSg, and outputs it to the tracking controlling unit 215.

With the control signal from the controller 201, the tracking controlling unit 215 outputs the tracking driving signal that corresponds to the output of the tracking error signal generating unit 214 or the tracking error signal generating unit 210 to the tracking driving unit 216.

When performing the recording on the recording layer, the recording layer focus servo control is performed so that the laser spot LSw may become in focus on the recording layer by driving the actuator 312 with the focus driving signal generated based on the recording layer focus error signal outputted from the focus error signal generating unit 211. In addition, the guide layer focus servo control is performed so that the laser spot LSg may become in focus on the guide layer by driving the relay lens 315 with the relay lens driving signal generated based on the guide layer focus error signal outputted from the focus error signal generating unit 217.

Moreover, with the control signal from the controller 201, the tracking controlling unit 215 outputs the tracking driving signal generated based on the guide layer tracking error signal outputted from the tracking error signal generating unit 210 to the tracking driving unit 216. The tracking driving unit 216 performs a tracking servo control so that the laser spot LSg may follow the track of the guide layer by driving the actuator 312 according to the tracking driving signal.

Moreover, a slider controlling unit 220 that received a control signal from the controller 202 outputs a slider driving signal for driving the slider motor 204 based on an average of the tracking driving signal. According to this slider driving signal, the slider driving unit 205 drives the slider motor 204 to translate the optical pickup 203 in a disk radial direction so that the actuator 312 may operate near a center position of a movable range in the disk radial direction. The data to be recorded on the recording layer inputted from the host 103 and the address information corresponding to a position on the disk on which the data is recorded are outputted from the controller 201 to the signal processing unit 202.

The signal processing unit 202 modulates the data and the address information that were inputted by a predetermined system based on the reference clock signal reproduced from the guide layer, and outputs them to the laser driver 301. The laser driver 301 outputs the drive current according to the output of the signal processing unit 202 to the laser diode 302, and the laser diode 302 emits the laser beam LBw at an intensity corresponding thereto, and thereby the recording is performed on the recording layer of the optical disk 102.

Since the recording is performed on the recording layer while the laser spot is following the track formed on the guide layer by this, the recording of information is performed on the recording layer with the same locus as a spiral of the track of the guide layer. For example, if the track of the guide layer is formed in the spiral shape toward the outer periphery from the inner periphery, a locus recorded on the recording layer will be formed in a spiral shape toward the outer periphery from the inner periphery, being similarly in all the layers.

When the information recorded on the recording layer is reproduced, by driving the actuator 312 with the focus driving signal generated based on the recording layer focus error signal outputted from the focus error signal generating unit 211, the recording layer focus servo control is performed so that the laser spot LSw may focus on the recording layer; by driving the relay lens 321 with the relay lens driving signal generated based on the guide layer focus error signal outputted from the focus error signal generating unit 217, the guide layer focus servo control is performed so that the laser spot LSg may focus on the guide layer.

Moreover, the tracking error detection unit 214 outputs a tracking error signal that corresponds to a deviation between the track comprised of the locus of the information recorded on the recording layer and the laser spot LSw irradiated on the recording layer. With the control signal from the controller 201, the tracking controlling unit 215 outputs the tracking driving signal generated based on the recording layer tracking error signal outputted from the tracking error signal generating unit 214 to the tracking driving unit 216. The tracking driving unit 216 performs the tracking servo control so that the laser spot LSw may follow the track comprised of a locus of the information recorded on the recording layer by driving the actuator 312 according to the tracking driving signal, and the detector 314 outputs the reproduced signal from the recording layer.

Moreover, the slider controlling unit 220 that received the control signal from the controller 202 outputs the slider driving signal for driving the slider motor 204 based on the average of the tracking driving signal. According to this slider driving signal, the slider motor 204 is driven by the slider driving unit 205 to translate the optical pickup 203 to the disk radial direction so that the actuator 312 may operate near the center position of the movable range in the disk radial direction.

The signal processing unit 202 generates the synchronizing signal for controlling the rotation of the optical disk 102 and the clock signal serving as a standard when performing the reproduction from the inputted reproduced signal. Moreover, the signal processing unit 202 performs processings, such as amplification, equalization, and demodulation, on the reproduced signal, and outputs the demodulated signal and address information corresponding to a position of the data on the disk to the controller 201. The controller 201 outputs the reproduced data to the host 103.

Incidentally, although the laser diode 302 and the laser diode 315 were driven by the same laser driver 301 here, individual laser drivers may be provided for respective laser diodes. Moreover, the spherical aberration correction element 309 may be arranged at a position at which it influences both a 405 nm optical system and a 650 nm optical system. For example, it may be arranged between the quarter wavelength plate 310 and the dichroic mirror 308.

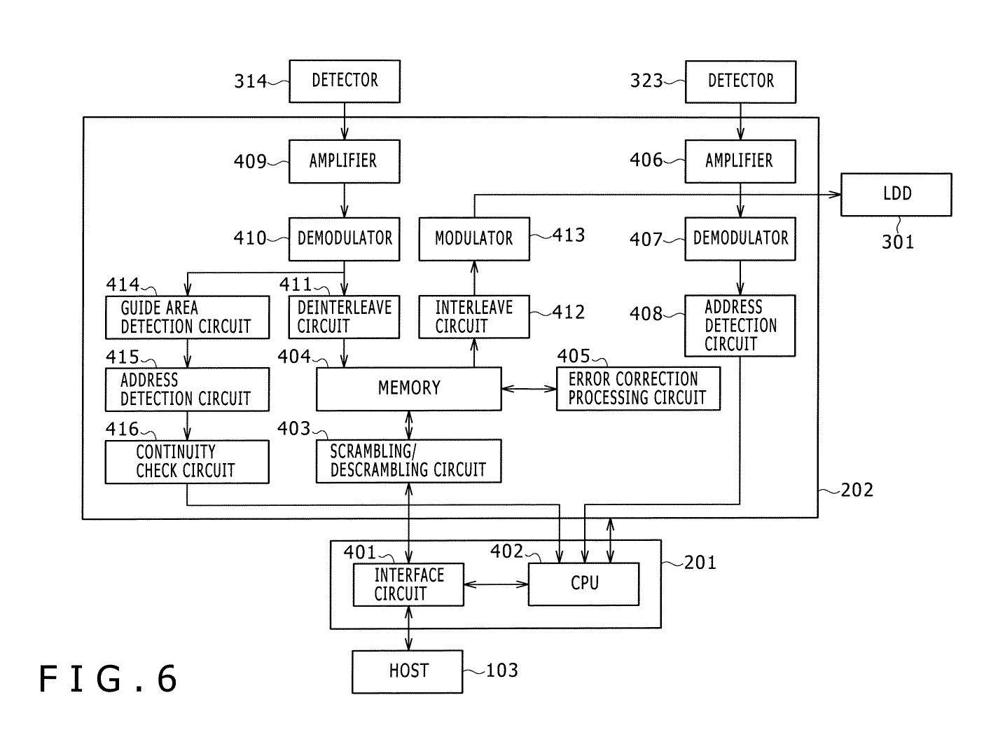

FIG. 6 is a block configuration diagram of the signal processing unit 202.

This signal processing unit 202 has: a scrambling/descrambling circuit 403 for scrambling data transmitted to an interface circuit 401 in the controller 201 from the host 103; memory for stacking the data; an error correction processing circuit 405 of detecting data having an error and correcting it; an amplifier 406 for amplifying a signal obtained from the detector 323 of the guide layer optical system; a demodulator 407 for restoring an original signal from the inputted signal; an address detection circuit 408 for detecting address information obtained from the wobble on the optical disk; an amplifier 409 for amplifying a signal obtained from the detector 314 of the recording layer optical system; a demodulator 410 for returning the inputted signal to an original signal; a deinterleave circuit 411 for successively rearranging an inputted data sequence whose pieces of data were rearranged into an original data; an interleave circuit 412 for successively rearranging the data sequence inputted from memory 404; a modulator 413 for converting the information into an electric signal optimal to be outputted to the LDD 301; a guide area detection circuit 414 for detecting a guide area in the present invention from data obtained from the demodulator 410; and an address detection circuit 415 for detecting the address information recorded in the guide area.

Next, an operation of the signal processing unit 202 when the data is recorded on the optical disk will be explained. When the data is sent from the host computer 103, the interface circuit 401 in the controller 201 receives it, and a scrambling/descrambling circuit 403 in the signal processing circuit 202 performs scrambling on it, which is stored in the memory 404. The error correction processing circuit 405 adds an error correcting code to the data stored in the memory 404, the interleave circuit 412 performs interleaving on the data, and the modulator 413 modulates the data, which is recorded on the optical disk through the LDD 301 at the following timing.

First, the amplifier 406 amplifies the signal inputted from the detector 323, the demodulator 407 demodulates the signal into data, and the address detection circuit 408 detects an address, and then seeking is performed to the address at which the recording is started. The amplifier 409 amplifies a signal inputted from the detector 314, the demodulator 410 demodulates the signal into data, the guide area detection circuit 414 detects a guide area, the address detection circuit 415 detects an address, and the continuity check circuit 416 checks whether the address values of the guide areas continue for a predetermined number of times.

If the values continue for a predetermined number of times, the seeking will be performed again to the address at which the recording is started and the data is recorded on the optical disk. If the values do not continue for a predetermined number of times, the adjustment processing is performed and subsequently the above-mentioned processing is redone.

Next, an operation of the signal processing unit 202 when the data is reproduced from the optical disk will be explained. The amplifier 409 amplifies the signal inputted from the detector 314, the demodulator 410 demodulates it into data, and the deinterleave circuit 411 performs deinterleaving on the data, which is stored in the memory 404. The scrambling/descrambling circuit 403 performs descrambling on the data that was subjected to an error correction processing in the error correction processing circuit 405, and sends it to the host computer 103 through the interface circuit 401 in the controller 201.

Incidentally, although the example where the hardware performed guide area detection and address detection in the above-mentioned signal processing unit was shown, the data may be stored in the memory temporarily and the CPU may detect these by software, but not limited to this example.

Moreover, although the example where the hardware performed continuity check of the addresses of the guide areas was shown, the CPU may perform the continuity check by software. An operation of the signal processing unit 202 when the guide area check processing is performed in this case will be explained. The amplifier 409 amplifies the signal inputted from the detector 314, the demodulator 410 demodulates it into data, the guide area detection circuit 414 detects the guide area in the present invention from the data obtained from the demodulator 410, the address detection circuit 415 detects the address information recorded in the guide area and sends it to a CPU 402, and the CPU 402 performs the continuity check.

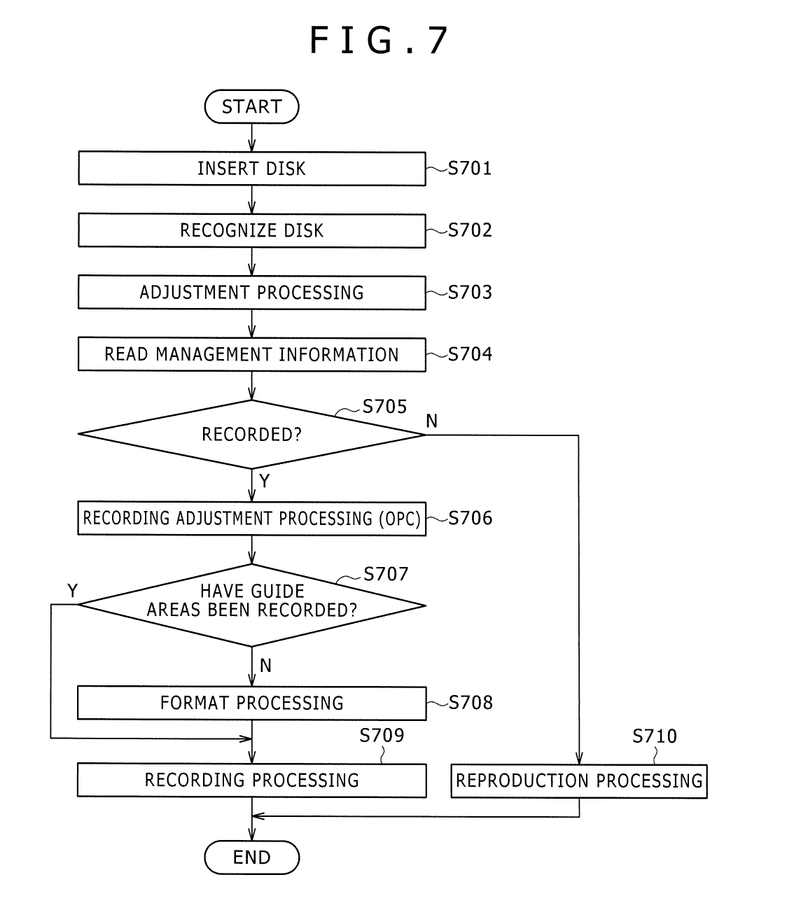

FIG. 7 shows a processing flow of the optical disk device 101 when the optical disk 102 is inserted into the optical disk device 101.

When the optical disk 102 is inserted into the optical disk device 101 at Step S701, the optical disk device 101 checks the existence and a disk type of the disk at Step S702. At this time, the optical disk device 101 can irradiate the optical disk 102 with a laser beam and can recognize it by reflected light, for example.

Next, at Step S703, the adjustment processing for making various parameters in the optical disk device 101 suitable is performed to the inserted optical disk 102. The adjustments of the various parameters include, for example, an adjustment of amplification factors of amplifiers included in the focus controlling unit 212 and the tracking controlling unit 215, an adjustment of a lens shift control and the tilt control using the relay lens controlling unit 218 to reflectivity of the optical disk 102, etc. After performing the adjustments of the various parameters, management information of the optical disk 102 is read at Step S704, and determination of recording or reproduction is performed in response to a command from the host 103 at Step S705.

If it is a reproduction operation, a predetermined address is reproduced at Step S709 and the operation is ended. If it is a recording operation, an adjustment of an output of the light emission waveform, such as an optimum recording power, is performed at Step S706 and it is determined whether the guide areas have been recorded at Step S707. The determination here is as follows: when an identification flag for determining whether the guide area has been recorded is recorded, if the already-recorded identification flag is found when the guide areas of a fixed interval are reproduced, it will be determined that the recording has been performed in the guide area. Alternatively, an area for recording the disk information in the inner or outer periphery of the optical disk 102 is provided, and information as to whether the optical disk 102 has been formatted, namely whether the recording has been performed in the guide area is described in that area.

The above-mentioned area is reproduced at Step S707, and if the recording has not been performed in the guide area, the format processing will be performed according to the present invention at Step S708 after this. By the format processing here, the address information as to serving as the guide area is recorded in the user data area.

Finally, the recording is performed at Step S709 and the operation is ended.

Incidentally, the timing of the adjustment processing Step S710 is not limited to this, and a part of the adjustment processing may be performed after management information read-out Step S704 or the like.

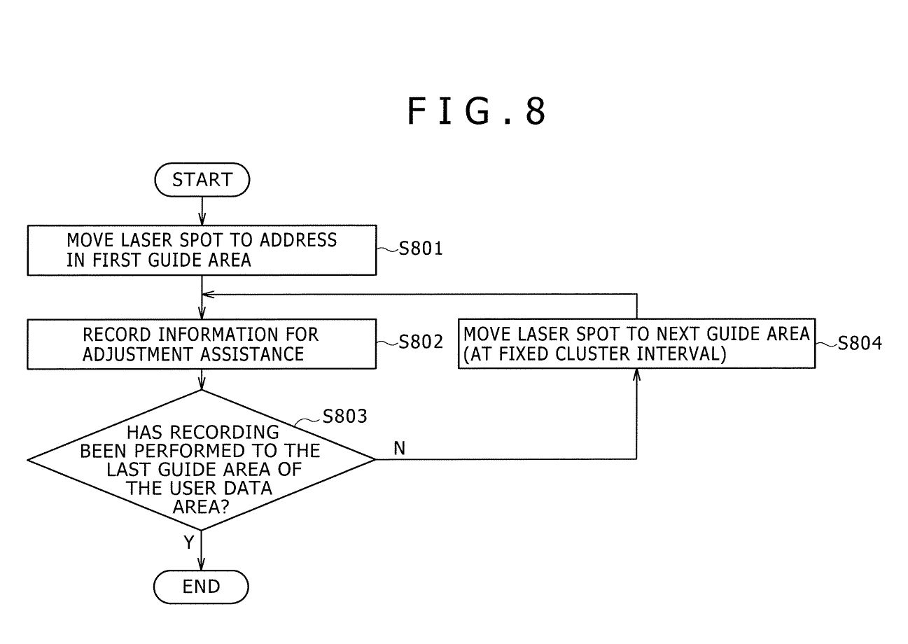

FIG. 8 shows a format processing flow. In order to perform the recording in the guide area at Step S801, the laser spot moves to an address position of the first guide area (hereinafter described as seeking). An address value of a position at which the laser beam is focusing is decided from the address information obtained from the guide layer at Step S802 and the layer information for distinguishing a layer on which the laser beam is focusing among the multiple recording layers, and the address value is recorded in the guide area.

The adjustment, such as the tilt control, is redone based on information reproduced from this guide area, and the adjustment assistance is performed so that the laser beam can track the virtual recording track formed by the guide area.

Next, it is determined whether the recording has been performed to the last guide area of the user data area at Step S803, and if the recording is not ended, the seeking of the next cluster will be performed at Step S804. When the recording has been performed to the last guide area of the user data area, the format processing is ended

Although the seek processing is performed for every recording of the guide area in this format processing flowchart, since the processing becomes fast provided that the processing is done within one cycle of the track, for example, the recording may be performed in each guide area by a control of the recording and reproduction with a write gate without performing the seeking, not limited to the above processing.

Moreover, although the example of performing the format processing on the whole surfaces of all the layers simultaneously was shown, for example, the formatting may be performed only on a layer where the recording is started among the multiple recording layers, but not limited to this example. If the amount of data is not stored in that layer, the recording may be interrupted temporarily and the next layer may be formatted. Alternatively, only the outermost layer where an influence of tilt is large may be formatted, and the adjustment may be performed on the outermost layer at each loading and the adjustment may be applied to other layers. Alternatively, in the case where the optical disk has the management area in the inner or outer periphery and the guide area exists in the area, only the guide area existing in the management area may be formatted. Alternatively, in the case where the guide area exists only in a certain defined zone, not in the whole surface of the user data area, only the guide area in the zone may be formatted.

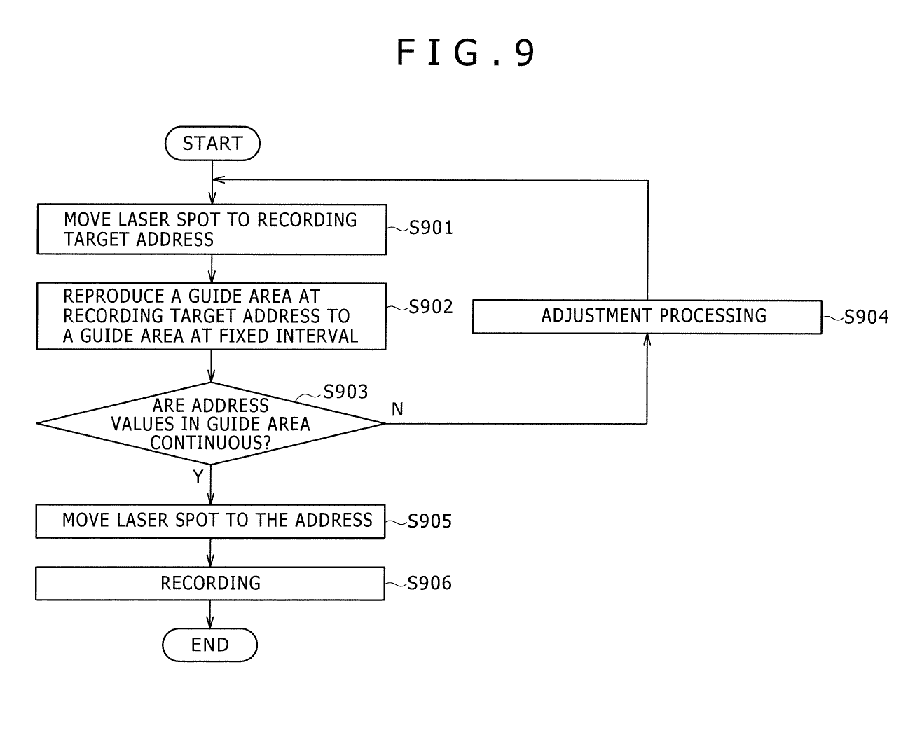

FIG. 9 shows a processing flow of the recording operation.

First, in order to perform the recording at Step S901, the seeking is performed to a recording target address. The guide areas at fixed intervals prescribed beforehand from the recording target address at Step S902 are reproduced. This interval includes at least two or more guide areas, whose number is sufficient provided that it equals to the number of guide areas included in an area necessary for the recording at most.

Next, it is determined whether the address values of the guide areas are continuous at Step S903. If the address values are non-continuous, the adjustment processing, such as the tilt adjustment, will be redone at Step S904, and the flow will return to the seeking of the recording target address at Step S901. If the address values of the guide areas are reproduced continuously, the laser spot will return to the recording target address at Step S905, and will start the recording at Step S906. In this way, by adjusting so that rotation along the virtual track may be realized in processings of Step S901 to Step S904 prior to the recording of the user data, it is possible to perform the recording always in a parallel track even when the disk is taken out from the drive temporarily, appending the data thereon.

In this embodiment, although the example of repeating the steps until it was determined that the address values of the guide areas were continuous was shown, there is a case where the adjustment does not complete even after a certain number of times of repetition or elapse of a certain time and the address values of the guide areas are not reproduced continuously. At this time, if the recording is being performed in the guide areas in the whole surface of the user data area, chucking will be redone using the optical disk device or an external system having a mechanism for performing the chucking again. Alternatively, in the case where the guide areas of all the layers among multiple layers are not being used, formatting may be performed anew on an unused recording layer. Alternatively, in the case where the optical disk has the management area in the inner or outer periphery and the area has the guide area in it, the formatting may be performed anew using an unused management area. Alternatively, in the case where the optical disk has guide areas only in a certain designated zone, not in the whole surface of the user data area, the formatting may be performed anew using a guide area in a zone other than the zone.

With the above configuration, in the first embodiment of the present invention, it is possible to perform the recording always in the parallel track and therefore to prevent data corruption, etc. by performing the adjustment processing using the guide area prior to the recording.

### Second Embodiment

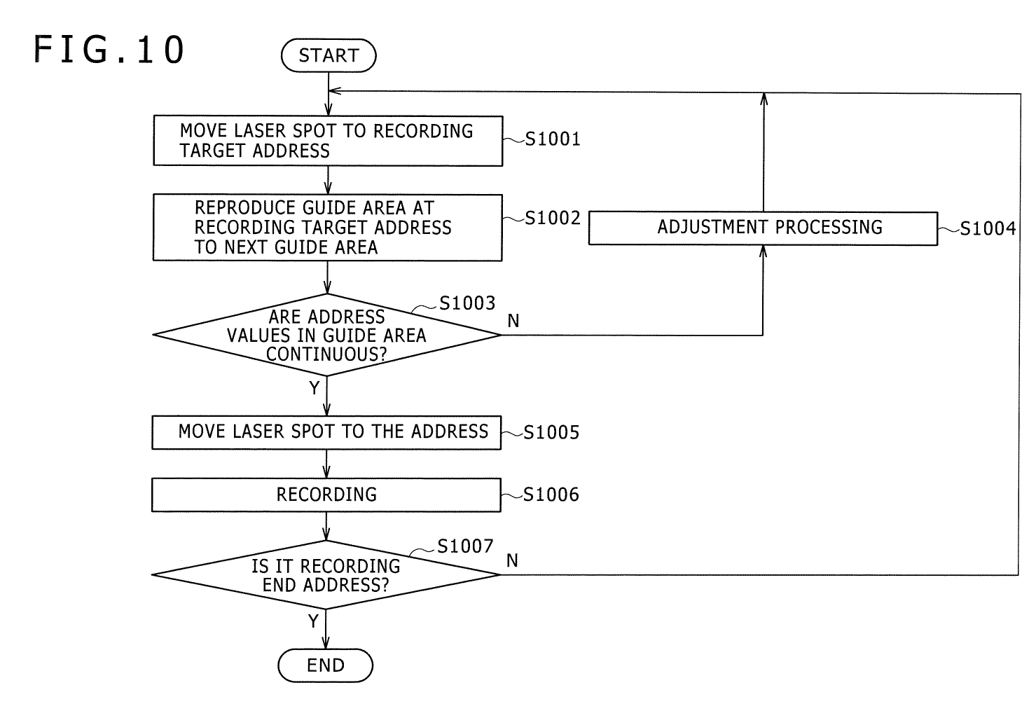

FIG. 10 shows a processing flow of a recording operation of a second embodiment according to the present invention.

In order to perform the recording at Step S1001, the seeking is performed to the recording target address. At Step S1002, the guide area at the recording target address to the next guide area are reproduced. At Step S1003, it is determined whether the address values of the guide areas are set continuous.

If the address values are non-continuous, the adjustment processing, such as the tilt adjustment, will be redone at Step S1004 and the flow will return to the seeking of the recording target address of Step S1001. When the address values of the guide areas are reproduced continuously, the laser beam returns to the recording target address at Step S1005, and starts the recording at Step S1006.

Finally, it is determined whether the current address is a recording end address at Step S1007, and if it is not the end address, the flow will return to Step S1001, where the next guide area will be checked. In the case of a disk with many in-surface tilts and in the case of intending to improve reliability, etc., performing the adjustment assistance in every guide area in this way makes it possible to perform data recording in that area surely.

With the above configuration, in the second embodiment of the present invention, it is possible to perform the recording always in the parallel track by performing the adjustment processing using the guide area prior to the recording and therefore to prevent the data corruption, etc. Furthermore, it is possible to perform the data recording surely compared with the first embodiment by checking the guide area every cluster.

### Third Embodiment

In this embodiment, the recording of the guide area is not performed at the time of formatting but the recording is performed during the recording processing of the user data in the guide area simultaneously, which will be described below.

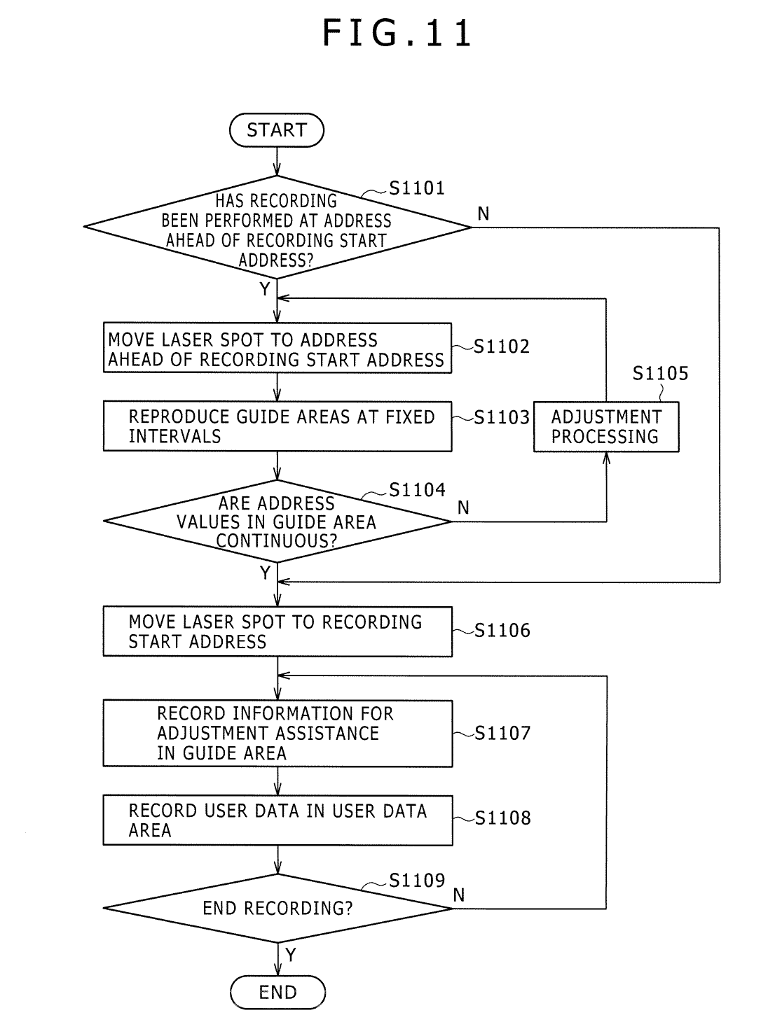

FIG. 11 shows a format processing flow of a third embodiment according to the present invention.

At Step S1101, it is determined whether the recording has been performed at an address ahead of a recording start address, and if it has been performed, the laser beam will seek to the address ahead of the recording start address at Step S1102, reproduces the guide areas at fixed intervals prescribed beforehand at Step S1103, and it will be determined whether the address values of the guide areas is continuous at Step S1104. If the address values are non-continuous, the adjustment processing, such as the tilt adjustment, will be redone at Step S1105 and the flow will return to the seeking to the address ahead of the start address of Step S1102. If the address values of the guide areas are reproduced continuously, in order to perform the recording in the guide area at Step S1106, the laser beam will seek to an address of the first guide area.

Incidentally, at Step S1101, it is checked whether the recording has been performed at the address ahead of the recording start address, and if it has not been performed, processings of Step S1102 to Step S1105 will not be performed.

An address value of a position at which the laser beam is focusing on the recording layer is decided from the address information obtained from the guide layer at Step S1107 and the layer information for distinguishing a layer on which the laser beam is focusing among the multiple recording layers, and the address value is recorded in the guide area. When the recording has been performed in the guide area, the recording of the user data is performed in an area contiguous to the guide area at Step S1108. Next, it is determined whether the recording has been ended at Step S1109, and if the recording has not been ended, Step S1107 and Step S1108 will be repeated until the recording is ended to record the guide area and the user data.

When performing the loading again and recording it, the guide area in the recorded area will be reproduced, and the recording processing will be performed with an adjustment in processings of Step S1102 to Step S1105. At this time, when the adjustment dose not complete even after a certain number of times of repetition or elapse of a certain time and the address values of the guide areas are not reproduced continuously, the recording is performed with a gap of several tracks provided so that the data corruption may not be caused even when the already-recorded portion and the track following are not in parallel, not performing the recording continuously from the already-recorded portion. Incidentally, although the example where the address information was recorded in the guide area during the recording was shown here, the address information may be recorded in Run-in, but not limited to this example.

With the above configuration, in the third embodiment of the present invention, by performing the adjustment processing using the guide area prior to the recording, it is possible to perform the recording always in the parallel track, and therefore to prevent the data corruption, etc.

Furthermore, when the adjustment processing does not complete even after a certain number of times of repetition or elapse of a certain time and the address values of the guide areas are not reproduced continuously, the recording can be preformed with a gap of several tracks provided so that the data corruption may be caused even when the already-recorded portion and track following are not parallel, not performing the recording continuously from the already-recorded portion, this scheme can support a case where the adjustment processing does not complete even when the reproduction is repeated for a certain number of times or for elapse of a certain time.

### Fourth Embodiment

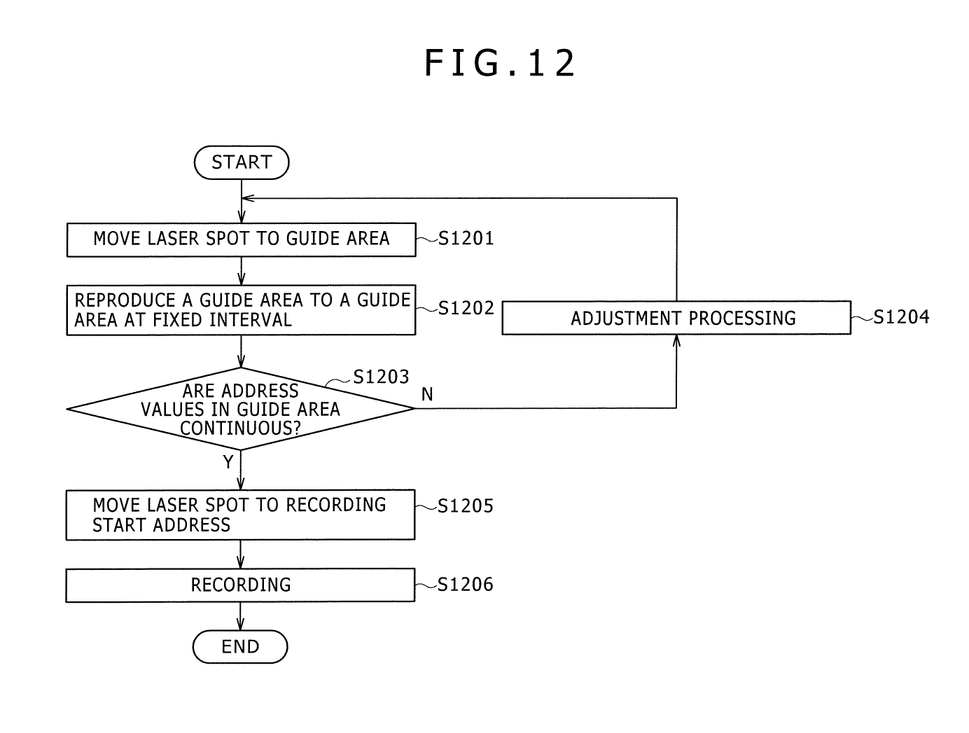

FIG. 12 shows a processing flow of a recording operation of a fourth embodiment according to the present invention.

First, in order to perform the adjustment processing at Step S1201, the seeking is performed in the guide area. Incidentally, the guide area is recorded in the management area, or the user data area, or the like in the inner or outer periphery of the optical disk.

The guide area check processing of reproducing the guide areas at fixed intervals prescribed beforehand from the recording target address at Step S1202 is performed. Next, it is determined whether the address values of the guide areas are continuous at Step S1203. If the address values are non-continuous, the adjustment processing, such as the tilt adjustment, will be redone at Step S1204 and the flow will return to the seeking of the recording target address at Step S1201. If the address values of the guide area are reproduced continuously, the laser beam will return to the recording target address at Step S1205 and start the recording at Step S1206.

In this way, by performing the adjustment processing so that rotation along the virtual track is established in processings of Step S1201 to Step S1204 prior to the recording of the user data, it is possible to perform the recording always in the parallel track even when the disk is taken out once from the drive and appending is performed after loading is redone.

Incidentally, although the example where the guide areas were recorded in the management area, or the user data area, or the like of the inner or outer periphery of the optical disk was shown, it may be recorded in the management area, or the user data area, or the like of the inner and outer peripheries, and the adjustment processing may be performed using one guide area that is nearer a recording position of the user data.

With the above configuration, in the fourth embodiment of the present invention, by performing the adjustment processing using the guide area prior to the recording, it is possible to perform the recording always in the parallel track and therefore to prevent the data corruption, etc.

Moreover, since the guide area is recorded only in partial areas of the optical disk, an occupancy area of the guide area can be decreased compared with the first embodiment.

Incidentally, the present invention is not limited to the above-mentioned embodiments, and various modifications are included. For example, the above-mentioned embodiments were explained in detail to explain comprehensively the present invention, and any embodiment shall not be necessarily limited to one having all the explained configurations. Moreover, a part of the configuration of a certain embodiment can be replaced with the configuration of the other embodiment, and a part of the configuration of the other embodiment can be added to a configuration of a certain embodiment. Furthermore, addition, deletion, and replacement of an other configuration can be performed on a part of the configuration of each embodiment.

Moreover, a part or the whole of each configuration, function, processing part, processing unit, etc. described above may be realized by hardware, for example, by designing it in an integrated circuit. Moreover, each of the above-mentioned configurations, functions, etc. may be realized by software by a processor interpreting a program that realizes each function and executing it. Pieces of information, such as a program, a table, and a file, that realize respective functions can be put in recording devices including memory, a hard disk drive, an SSD (Solid State Drive), etc. or in recording media including an IC card, an SD card, etc.

Moreover, the control line and the information line that are necessary for explanations are shown, and all the control lines and information lines are not necessarily shown on the product. It may be also conceivable that almost all the configurations are connected mutually in fact.

What is claimed is:

1. An optical disk that comprises a guide layer with a physical groove structure containing address information and at least one recording layer with no groove structure,
wherein the recording layer has guide areas each in a non-recorded state for recording the address information in an area along a track of the guide layer at fixed intervals.

2. A format processing method of the optical disk according to claim 1, comprising:
moving a laser spot to a recording target position of the guide area of the recording layer;
generating an address for the recording layer based on information obtained from the guide layer; and
recording the address for the recording layer in the guide area,
wherein the method repeats the steps until the addresses are recorded in the guide areas of all the recording layers.

3. A recording method for recording user data on an optical disk that has been formatted by the format processing method according to claim 2, the recording method comprising:
moving the laser spot to the recording target position of the recording layer;
reproducing a fixed number of the guide areas starting from the guide area at the recording target position;
determining whether the address information of the reproduced guide areas is continuous; and
performing an adjustment processing so that a scanning direction agreeing with a virtual recording track along the guide areas may be established when the address information of the reproduced guide areas is non-continuous,
wherein the steps are repeated until the address information of the reproduced guide areas is determined to be continuous, and when the address information is determined to be continuous, the user data is recorded in a predetermined area between the guide areas.

4. An optical disk device for recording user data on the optical disk according to claim 1, comprising:
a laser diode;
a current supplying unit which supplies a current for emitting the laser diode;
an emission controlling unit which controls an emission power of the laser diode by controlling the amount of current that the current supplying unit supplies to the laser diode;
a focus control part which adjusts an objective lens in a focusing direction of the disk by changing variably a driving voltage in order to focus a laser beam on the recording layer and on the guide layer;
a tracking control part which adjusts an actuator in a track direction of the disk according to a tracking error signal indicating the amount of positional deviation between a track on the guide layer and a laser spot on the guide layer;
a detector which detects reflected light reflected on the optical disk; and
a signal processing part which converts a signal obtained from the detector,
wherein an address for the recording layer is generated based on information obtained from the guide layer of the optical disk and the address for the recording layer is recorded in the guide area.

5. A recording method of an optical disk according to claim 3, comprising:
reproducing the address information of the guide area prior to the recording of the user data;
determining whether the address information of the reproduced guide areas is continuous; and
performing the adjustment processing if the address information of the reproduced guide areas is non-continuous,
wherein when the address information of the reproduced guide areas is determined to be non-continuous, the recording processing of the user data is interrupted, or when it is determined to be continuous, the user data is recorded between the guide areas.

6. A recording method for recording an address and user data on the optical disk according to claim 1, comprising:
moving a laser spot to an address ahead of a recording target position of the recording layer by a fixed interval;
reproducing the guide areas from the address ahead of the recording target position by the fixed interval to the recording target position;
determining whether the address information of the reproduced guide areas is continuous; and
performing an adjustment processing so that a scanning direction may become to agree with a virtual recording track along the guide areas,
wherein the steps are repeated until the address information of the reproduced guide areas is determined to be continuous, and when the address information is determined to be continuous, the address information is recorded in the guide area starting from the recording target position and the user data is recorded between the guide areas.

7. An optical disk having a guide layer with a physical groove structure containing address information and at least one recording layer with no groove structure,
wherein a specific recording layer of the at least one recording layer has guide areas that are in a non-recorded state and for recording the address information in a specific range within a user data area along a track of the guide layer at fixed intervals.

8. A format processing method of the optical disk according to claim 7, comprising:
moving a laser spot to a recording target position of the guide area of the recording layer; and
recording the address information at fixed intervals prescribed beforehand by referring to a timing obtained from the guide layer,
wherein the format processing method records the address information in the guide areas in a specific range of a specific recording layer.

9. A recording method for recording user data on an optical disk that is formatted by the format processing method according to claim 8, comprising:
reproducing the guide areas in the specific range of the specific recording layer;
determining whether the address information of the reproduced guide areas is continuous; and
performing an adjustment processing so that a scanning direction may become to agree with a virtual recording track along the guide areas when the address information of the reproduced guide areas is non-continuous,
wherein the steps are repeated until the address information of the reproduced guide areas is determined to be continuous, and when the address information is determined to be continuous, the laser spot is moved to the recording target position of the recording layer and records the user data.
